(19) United States
(12) Patent Application Publication
(10) Pub. No.: US 2019/0356617 A1
(43) Pub. Date: Nov. 21, 2019

(54) BUSINESS CHAT TO RICH COMMUNICATION SERVICES INTERWORKING

(71) Applicant: T-Mobile USA, Inc., Bellevue, WA (US)

(72) Inventors: Adrian SYNAL, Kirkland, WA (US); Shelby SEWARD, North Bend, WA (US)

(21) Appl. No.: 15/981,826

(22) Filed: May 16, 2018

(51) Int. Cl. H04L 12/58; H04L 29/06; H04L 29/08

(52) U.S. Cl. CPC H04L 51/046; H04L 65/1016; H04L 67/42; H04L 67/30; H04L 65/1066; H04L 65/1006

(57) ABSTRACT

An example method is performed by a rich communications services (RCS) server. The RCS server receives a business chat message and corresponding token from a business chat server. The business chat message is formatted according to a third-party proprietary protocol to include a plurality of message attributes. At least one of the message attributes is associated with an intended recipient of the business chat message. The RCS server is configured to convert the business chat message into an RCS message, where converting the business chat message into the RCS message includes mapping the plurality of message attributes to a plurality of message parameters included in the RCS message. The RCS server is also configured to query a profile database with the at least one message attribute to obtain an identification (ID) of the intended recipient and to send the RCS message to the intended recipient based on the ID.

### BACKGROUND

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

Access networks using various communication protocols (e.g., 3GPP access networks such as W-CDMA, LTE, etc., or non-3GPP access networks such as WiFi, WLAN or wired LAN, etc.) can be configured to provide Internet Protocol (IP) Multimedia Subsystem (IMS) services via an IMS network managed by a mobile network operator (e.g., T-MOBILE) to users across a communications system. Users that access the IMS network to request an IMS service are assigned to one of a plurality of regional application servers or application server clusters (e.g., groups of application servers that serve the same cluster region) for supporting the requested IMS service.

One type of communication that may be supported by IMS services may be referred to as Rich Communication Services (RCS). RCS is designed to provide enhanced communications between mobile devices, including mobile devices that are supported by different operators. Among other things, RCS provides for enhanced messaging, which may include chat, file sharing, location sharing, and so forth.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture of a wireless communication network.

FIG. 2 illustrates an example of an Internet Protocol (IP) multimedia subsystem (IMS) session architecture.

FIG. 3 illustrates examples of user equipments (UEs).

FIG. 4 illustrates an example Rich Communications Services (RCS) server.

FIG. 5 is a flow diagram of an example process for business chat to RCS interworking.

FIG. 6 is a flow diagram of an example process for RCS to business chat interworking.

### DETAILED DESCRIPTION

Aspects of the present disclosure are directed to a rich communications services (RCS) server, computer-readable media, and processes for business chat to RCS interworking.

In one aspect, RCS combines different services defined by 3GPP and Open Mobile Alliance (OMA) with an enhanced phonebook. For example, one UE's capabilities and presence information can be discovered and displayed by another UE. RCS reuses the 3GPP-specified IMS core system as the underlying service platform taking care of issues such as authentication, authorization, registration, charging and routing.

As will be described in more detail below, an RCS server, according to aspects of the present disclosure, may be configured to provide enhanced messaging services, such as Standalone Messaging, 1-to-1 Chat, Open Group Chat, File Transfer, Content Sharing, Social Presence Information, IP Voice call, Best Effort Video call, Geolocation Exchange, Audio Messaging, Network based blacklist, and Capability Exchange, just to name a few.

Recently, some service providers (e.g., APPLE®) have begun providing business chat services to their customers. In some aspects, the service provider may maintain a business chat server that connects businesses with their customers to answer questions, schedule appointments, make payments, and more. In some examples, the business chat server makes the connection with customers possible by integrating with the business's existing customer contact center.

Through communication with the business chat server, a customer discovers a business using applications, services, and features (for example, voice-assistant, maps, web-browser, etc.), then chats with the business using a messaging app on their device.

In some aspects, the business chat server is configured to exchange messages with the business by way of a Customer Service Platform (CSP), which is a web service implemented by the business or a third party. The CSP provides an abstraction layer between the business chat server and the business's customer contact center. Using the CSP, business chat services can support any customer contact center in use by businesses.

However, the messages generated by the business chat server are often formatted according to a proprietary third-party protocol. Thus, in order to utilize the business chat services, both the customer and the business may be required to have software and/or access to software/devices that are capable of sending and receiving the proprietary messages.

For example, in some aspects, the business chat messages forwarded by a business chat server may be formatted according to the iMessage protocol developed by Apple, Inc. iMessage allows users to send texts, documents, photos, videos, contact information, and group messages to other iOS or macOS users, thus providing an alternative to standard SMS/MMS messaging for most users with devices running iOS 5 or later.

iMessage is typically accessible through a proprietary messaging application on an iPhone, iPad or iPod touch running iOS 5 or later or on a Mac running OS X Mountain Lion or later. Owners of these devices can register one or more email addresses with Apple, and, additionally, iPhone owners can register their phone numbers with Apple, provided their carrier is supported. When an iMessage is sent to a mobile number, the messaging application will check with Apple if the mobile number is set up for iMessage. If it is not, the message will seamlessly transition from iMessage to SMS.

The iMessage protocol is based on the Apple Push Notification Service (APNs)—a proprietary, binary protocol. In some aspects, a binary protocol is a protocol which is intended to be read by a machine rather than a human being, as opposed to a plain text protocol such as IRC, SMTP, or HTTP. Binary protocols have the advantage of terseness, which translates into speed of transmission and interpretation.

Accordingly, aspects of the present disclosure include an RCS server that is configured to maintain interoperability between a business chat server that generates proprietary business chat messages and one or more subscribers of a mobile network operator (MNO) that utilize RCS services. For example, the RCS server may be configured to receive a business chat message that is formatted according to a third-party proprietary protocol (e.g., iMessage, Facebook Messages, Skype for Business messages, etc.) and to convert the business chat message into an RCS message that may then be sent to the intended recipient of the business chat message. As will be described in further detail below, the RCS server may also be configured to query a profile database with at least one message attribute of the business chat message to determine an identity (ID) of the intended recipient, such that the RCS message may be sent to the correct location.

A client device, referred to herein as a user equipment (UE), may be mobile or stationary and may communicate with a radio access network (RAN) or any other appropriate network. As used herein, the term “UE” may be referred to interchangeably as an “access terminal” or “AT”, a “wireless device”, a “subscriber device”, a “subscriber terminal”, a “subscriber station”, a “user terminal” or “UT”, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.).

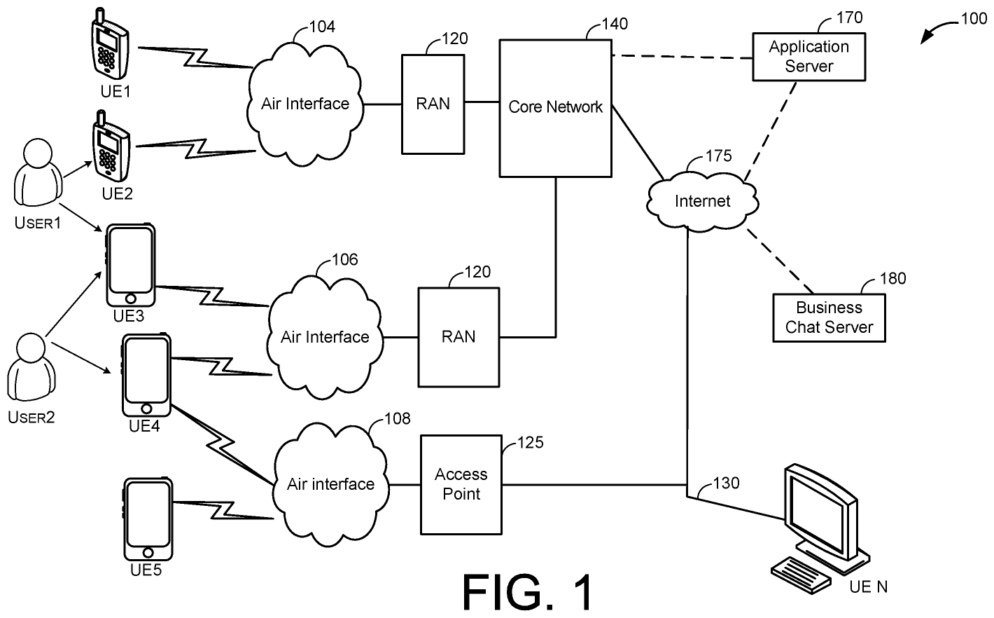

FIG. 1 illustrates a high-level system architecture of a wireless communication network 100 in accordance with various aspects. The wireless communication network 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or laptop.

Referring to FIG. 1, UEs 1 . . . N are configured to communicate with an access network (e.g., RANs 120, an access point 125, etc.) over a physical communications interface or layer, shown in FIG. 1 as air interfaces 104, 106, 108 and/or a direct wired connection 130. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N−1 via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection 130 to the Internet 175, such as a direct connection to a modem or router, which can correspond to the access point 125 itself in an example (e.g., for a WiFi router with both wired and wireless connectivity).

The core network 140 is configured to support one or more communication services (e.g., Voice-over-Internet Protocol (VoIP) sessions, Push-to-Talk (PTT) sessions, group communication sessions, social networking services, etc.) for UEs that can connect to the core network 140 via the RANs 120 and/or via the Internet 175, and/or to provide content (e.g., web page downloads) to the UEs.

Referring to FIG. 1, a server 170 is shown as connected to the Internet 175, the core network 140, or both. The server 170 can be implemented as a plurality of structurally separate servers, or alternately may correspond to a single server. As will be described below, server 170 may be an RCS server that is configured to provide RCS services to one or more subscribers of a mobile network operator (MNO).

FIG. 1 further illustrates a business chat server 180 that is configured to communicate with the server 170 via the Internet 175. In one aspect, server 170, core network 140 and one or more of the RANs 120 and APs 125 may be owned and operated by a MNO (e.g., T-MOBILE®), whereas the business chat server 180 may be owned and operated by a third party (e.g., APPLE®, MICROSOFT®, FACEBOOK®, etc.).

In some examples, the business chat server 180 is configured to provide one or more business chat services to their customers. That is, the business chat server 180 may be configured to connect businesses with their customers to answer questions, schedule appointments, make payments, and more. In some examples, business chat server 180 communicates via the Internet 175 to allow a customer to discover a business using applications, services, and features (for example, voice-assistant, maps, web-browser, etc.). The business chat server 180 then allows the customer to chat with the business using a messaging app on their device. In some aspects, the business chat server 180 is configured to send the business chat messages to the server 170 via the internet 175. In response, the server 170 may convert the business chat message into an RCS message and forward the RCS message to the business (e.g., to one or more subscribers of the MNO and/or to a Customer Service Platform (CSP) of the business).

The wireless communication network 100 may provide for multi-user to multi-device capabilities. That is, the same user may utilize multiple different devices to access the wireless communication network 100 and multiple different users may utilize the same device to access the wireless communication network 100. For example, as shown in FIG. 1, user1 may utilize UE2 as well as UE3 to access wireless communication network 100. Similarly, user2 may utilize the same UE3 as well as a different UE (i.e., UE4) to access the wireless communication network 100.

As mentioned above, access networks using various communication protocols (e.g., 3GPP access networks such as W-CDMA, LTE, etc., or non-3GPP access networks such as WiFi, WLAN or wired LAN, IEEE 802, IEEE 802.11, etc.) can be configured to provide Internet Protocol (IP) Multimedia Subsystem (IMS) services via an IMS network managed by a mobile network operator (MNO) to users across a communications system. Users that access the IMS network to request an IMS service are assigned to one of a plurality of regional application servers or application server clusters (e.g., groups of application servers that serve the same cluster region) for supporting the requested IMS service.

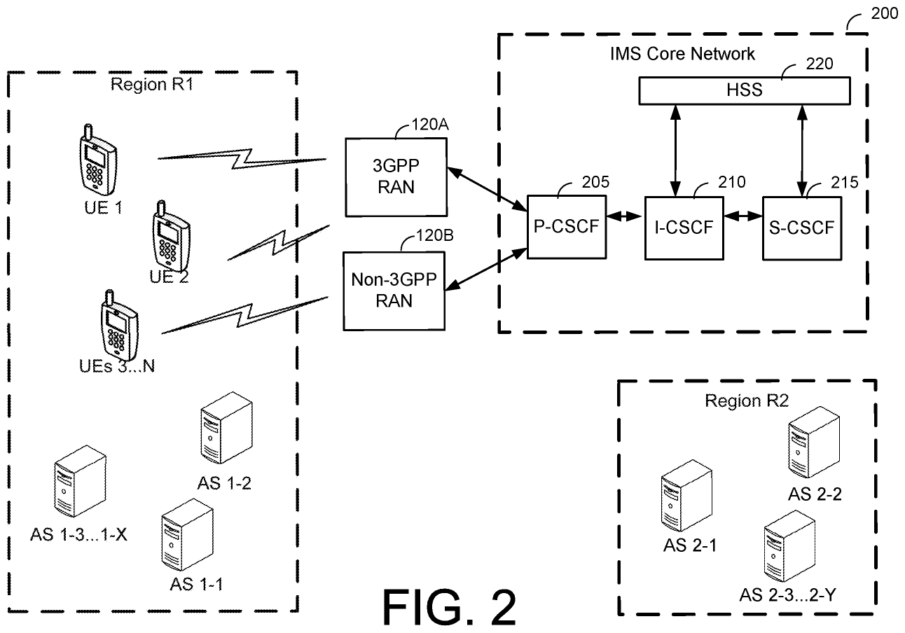

FIG. 2 illustrates an example of an IMS architecture. In one example, an IMS core network 200 is provided within core network 140 of FIG. 1, and application servers AS 1-1, AS 1-2 . . . AS 1-X and AS 2-1, AS 2-2 . . . AS 2-Y are represented by application server 170 of FIG. 1. With respect to FIG. 2, assume that a first cluster of application servers denoted as AS 1-1, AS 1-2 . . . AS 1-N is configured to provide IMS services to UEs and is located (or deployed) in a first region R1, and that a second cluster of application servers denoted as AS 2-1, AS 2-2 . . . AS 2-N configured to provide IMS service to UEs is located (or deployed) in a second region R2. While not shown in FIG. 2 explicitly, other clusters of application servers can be deployed in other cluster regions as well. In FIG. 2, each cluster of application servers is assumed to be operated by the same MNO. In FIG. 2, UEs 1 . . . N are assumed to be operating in cluster region R1 and are configured to connect either to a 3GPP RAN 120A (e.g., any of RANs 120 from FIG. 1) or a non-3GPP RAN 120B (e.g., a wired Ethernet connection, a WiFi connection such as AP 125, etc.). UEs 1 . . . N can then connect to an IMS network 200 through either the 3GPP RAN 120A or the non-3GPP RAN 120B.

The IMS network 200 is shown as illustrating a particular set of IMS components, including a proxy call session control function (P-CSCF) 205, an interrogating CSCF (I-CSCF) 210, a serving CSCF (S-CSCF) 215 and a Home Subscriber Server (HSS) 220. The P-CSCF 205, I-CSCF 210 and S-CSCF 215 are sometimes referred to collectively as the CSCF, and the CSCF is responsible for signaling via Session Initiation Protocol (SIP) between the Transport Plane, the Control Plane, and the Application Plane of the IMS network 200.

In one aspect, P-CSCF 205 is responsible for interfacing directly with Transport Plane components and is the first point of signaling within the IMS network 200 for any end-point, such as UEs 1 . . . N. Once an end-point acquires IP connectivity, the end-point will cause a registration event to occur by first signaling to the P-CSCF 205. As the name implies, the P-CSCF 205 is a proxy for SIP messages from end-points to the rest of the IMS network 200. It is usually in a home network of the end point, but may reside in a visited network of the end point. The P-CSCF 205 will use a DNS look-up to identify a target I-CSCF 210 to send SIP messages, which could be an I-CSCF 210 in its own network or another I-CSCF across an administrative domain. The P-CSCF 205 can also be responsible for policy decisions (e.g., via an integrated or standalone Policy Decision Function (PDF) in Releases 5 or 6 of IMS, via a Policy Charging, and Resource Function (PCRF) in Release 7 of IMS, etc.).

Still referring to FIG. 2, one function of the I-CSCF 210 is to proxy between the P-CSCF 205 as an entry point and S-CSCF 215 as a control point for applications found in the Applications Plane. When the P-CSCF 205 receives a registration request SIP message, it will perform a DNS look-up to discover the appropriate I-CSCF 210 to route the message. Once the I-CSCF 210 receives the SIP message, it will perform a look-up operation with the HSS 220 via Diameter (or other MNO specific protocol) to determine the S-CSCF 215 that is associated with the end-point terminal. Once it receives this information, it will forward the SIP message to the appropriate S-CSCF 210 for further treatment.

The S-CSCF 215 is responsible for interfacing with the Application Servers (AS) (e.g., such as AS 1-1, 1-2 . . . 1-X in cluster region R1, or AS 2-1, 2-2 . . . 2-Y in cluster region 2, and so on) in the Application Plane. Upon receiving a registration request SIP message from an I-CSCF 210, the S-CSCF 215 will query the HSS 220 via Diameter protocol to register the terminal as being currently served by itself. Subsequent session establishment requires knowing which S-CSCF 215 is responsible for the terminal session control. As part of the registration process, the S-CSCF 215 uses credentials it obtains from the query to the HSS 220 to issue an SIP message “challenge” back to the initiating P-CSCF 205 to authenticate the terminal.

In addition to acting as a registrar, the S-CSCF 215 is also responsible for routing SIP messages to the AS allowing for the Control Plane session control to interact with the Application Plane application logic. To do this, the S-CSCF 215 uses information obtained from the HSS 220 in the form of Initial Filter Criteria (IFC) that acts as triggers against inbound session establishment requests. The IFC includes rules that define how and where SIP messages should be routed to the various application servers that may reside in the Application Plane. The S-CSCF 215 may also act on Secondary Filter Criteria (SFC) obtained from the application servers during the course of messaging with them.

In one example, a UE that requests IMS service (e.g., registration to set-up or join a VoIP session, a PTT session, a group communication session, etc.) from the IMS network 200 is assigned (or registered) to a target application server that is selected by the S-CSCF 215, as noted above. Generally, the IMS network 200 will attempt to select, as the target application server, an application server that is physically close to the UE and is also known to be capable of providing the requested IMS service.

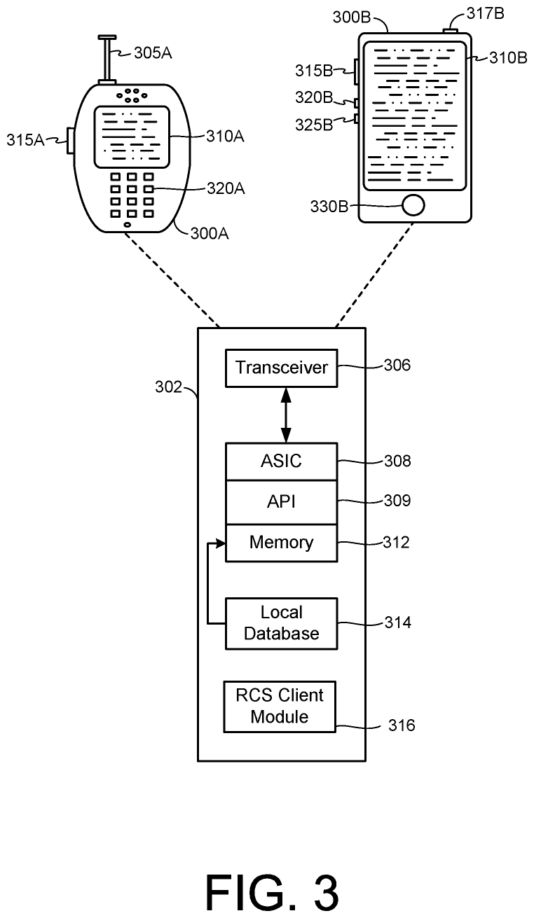

FIG. 3 illustrates examples of UEs (i.e., client devices) in accordance with embodiments of the invention. UEs 300A and 300B are possible implementations of any of the UEs 1-N of FIG. 1. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 310B, peripheral buttons 315B, 317B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 309 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the platform 302 is illustrated as including an RCS client module 316. In one aspect, RCS client module 316 may be configured to access an IMS network to request one or more IMS services (e.g., chat communications). With regards to chat communications, the RCS client module 316 may be configured to present a history of communications between parties. In some examples, RCS client module 316 may differentiate between outgoing messages and incoming messages, where outgoing messages are the messages sent by the user of the device and incoming messages are the messages received from other users. For example, outgoing messages may be displayed on one side of a display window and incoming messages may be displayed on the other side of the display window. In the case where multiple devices are associated with a single user, all communications originating from that user should be shown as outgoing, regardless of which of the user's devices actually sent the message and regardless of which of his or her devices the user is currently using.

Thus, in some aspects, the ASIC 308, memory 312, API 309, local database 314, and RCS client module 316 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the invention is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. Voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

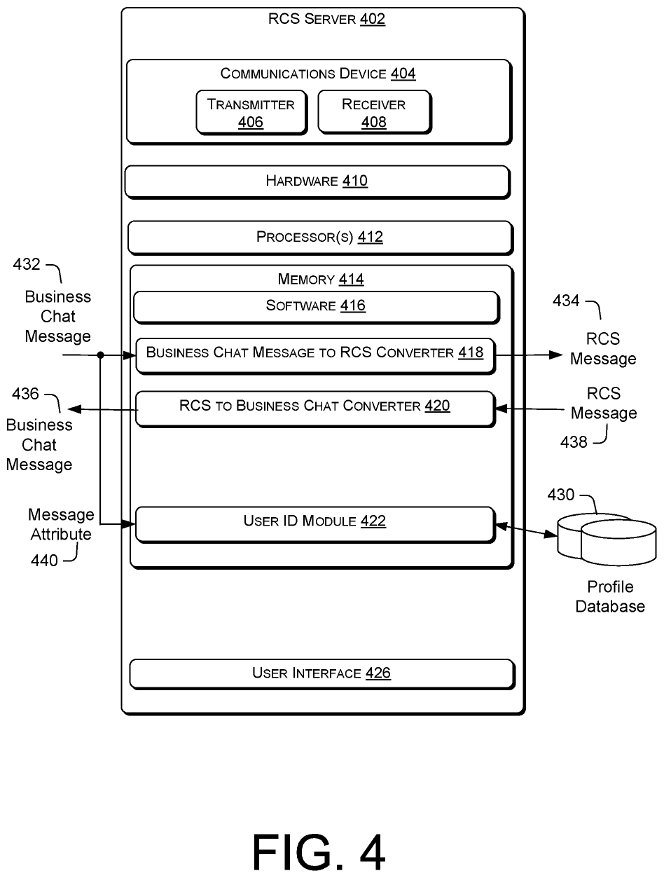

FIG. 4 illustrates an example RCS server 402. RCS Server 402 is one possible implementation of Application Server 170 of FIG. 1 and/or any of the application servers AS 1-1, AS 1-2 . . . AS 1-N or AS 2-1, AS 2-2 . . . AS 2-N of FIG. 2. The components illustrated in FIG. 4 may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The RCS server 402 may include at least one communication device (represented by the communication device 404) for communicating with other nodes. For example, the communication device 404 may comprise a network interface that is configured to communicate with one or more network entities via wire-based or wireless links. In some aspects, the communication device 404 may be implemented as a transceiver configured to support wire-based or wireless signal communication. This communication may involve, for example, sending and receiving: messages, parameters, or other types of information. Accordingly, in the example of FIG. 4, the communication device 404 is shown as comprising a transmitter 406 and a receiver 408.

The RCS server 402 may also include other components that may be used in conjunction with the operations as taught herein. For example, the RCS server 402 may include hardware 410, one or more processors 412, memory 414, and a user interface 426.

The hardware 410 may include additional hardware interfaces, data communications, and/or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

In addition, the RCS server 402 may include a user interface 426 for providing indications (e.g., audible and/or visual indications) to a user and/or for receiving user input (e.g., upon user actuation of a sensing device such a keypad, a touch screen, a microphone, and so on).

The memory 414 may be implemented using computer-readable media, such as computer storage media. Computer-readable media includes, at least, two types of computer-readable media, namely computer storage media and communications media. Computer storage media includes volatile and non-volatile, removable and non-removable, and non-transitory media, implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The processor 412 of server 402 may execute instructions and perform tasks under the direction of software components that are stored in memory 414. For example, the memory 414 may store various software components that are executable or accessible by the one or more processors 412 of the server 402. The various components may include software 416, a business chat message to RCS converter 418, a RCS message to business chat converter 420, and a user ID module 422.

The software 416, business chat message to RCS converter 418, RCS message to business chat converter 420, and user ID module 422 may include routines, program instructions, objects, and/or data structures that perform particular tasks or implement particular abstract data types. For example, the business chat message to RCS converter 418 may include one or more instructions, which when executed by the one or more processors 412 direct the RCS server 402 to perform operations related to converting a business chat message 432 that is formatted according to a third-party proprietary protocol into an RCS message 434. In some aspects, the RCS message 434 generated by the business chat message to RCS converter 418 is a session initiation protocol (SIP) message or message relay protocol (MSRP) message.

In one aspect, the business chat messages 432 are formatted according to the third-party protocol to include a plurality of message attributes (e.g., content-type, content-encoding, source-id, destination-id, etc.). Thus, the business chat message to RCS converter 418 may be configured to map the message attributes to message parameters of the RCS message 434. Table 1, below, illustrates an example mapping of a business chat message (e.g., iMessage) attributes to RCS message parameters that may be utilized by the business chat message to RCS converter 418.

TABLE 1

| iMessage | | RCS | | |
|---|---|---|---|---|
| Attributes | Type | Parameter | Type | Comments |
| content- | HTTP | N/A | | |
| type | Header | | | |
| content- | HTTP | N/A | | If content-encoding = gzip, then gunzip the |
| encoding | Header | | | body during conversion |
| authorization | HTTP | N/A | | CBP validates the authorization header as |
| | Header | | | per |
| | | | | https://developer.apple.com/library/content/documentation/General/ |
| | | | | Conceptual/MessagesIntegration/GettingStarted.html#// |
| | | | | apple_ref/doc/uid/TP40017634-CH19-SW2 |
| send-token | HTTP | N/A | | CBP validates the presence of the token as |
| | Header | | | per |
| | | | | https://developer.apple.com/library/content/documentation/General/ |
| | | | | Conceptual/MessagesIntegration/GettingStarted.html#// |
| | | | | apple_ref/doc/uid/TP40017634-CH19-SW3 |
| id | HTTP | imdn.Message-ID | CPIM Header | |
| | Header | | | |
| source-id | HTTP | From | SIP Header | |
| | Header | From | CPIM Header | |
| destination- | HTTP | RURI | SIP URI | Translated by the CBP to the corresponding |
| id | Header | To | SIP Header | routable business UID address for the |
| | | P-Associated-To | SIP Header | INVITE |
| | | To | CPIM Header | |
| “id” | JSON Value | imdn.Message-ID | CPIM Header | |
| “sourceId” | JSON Value | From | SIP Header | |
| | | From | CPIM Header | |
| “destination | JSON Value | RURI | SIP URI | |
| Id” | | To | SIP Header | |
| | | To | CPIM Header | |
| “type” | JSON Value | content-type | CPIM Header | “text” is mapped to “text/plain; |
| | | | | charset = UTF-8” |
| “body” | JSON Value | <CPIM body of | CPIM Body | |
| | | message> | | |
| “v” | JSON Value | N/A | | Not Mapped |
| | | NS: TMO | CPIM Header | Set to the source of the message, for |
| | | <mailto:rcs@t- | | example: |
| | | mobile.com> | | Apple Business Chat = iMessage |
| | | TMO.source | | Skype for Business = BusinessSkype |
| | | imdn.Disposition- | CPIM Header | Set to the default value of: positive-delivery |
| | | Notification | | |
| | | Content-Length | CPIM Header | Set by the CBP to be the length of the |
| | | | | payload of the CPIM message. |
| | | Conversation-ID | SIP Header | CBP generated unique ID for the message |
| | | Contribution-ID | SIP Header | CBP generated unique ID for the message |
| sourceId | JSON Value | P-Asserted-Identity | SIP Header | Translated by the CBP to the corresponding |
| | | | | routable originating user's address |
| | | Expires | SIP Header | Set as per service provider policy. |
| | | Content-Type | SIP Header | Set to the default value of SIP INVITE for |
| | | | | chat: application/sdp |
| | | Content-Length | SIP Header | Set by the CBP to be the length of the SIP |
| | | | | payload |
| | | Call-ID | SIP Header | Set by the CBP according to [RFC3261]. |
| | | User-Agent | SIP Header | Set to the value of the CBP |
| | | Cseq | SIP Header | Set by the CBP according to [RFC3261]. |
| | | Max-Forwards | SIP Header | Set by the CBP according to [RFC3261]. |
| | | Via | SIP Header | Set to the address of the CBP |
| | | Contact | SIP Header | Set by the CBP including the CPM Feature |
| | | | | Tag (i.e., “3gpp- |
| | | | | service.ims.icsi.oma.cpm.session”) |
| | | | | according to Appendix H of the [OMA-CPM- |
| | | | | TS-Conv-Func] and [RFC3841]. |
| | | Accept-Contact | SIP Header | Set by the CBP including the CPM Feature |
| | | | | Tag (i.e., “3gpp- |
| | | | | service.ims.icsi.oma.cpm.session”) |
| | | | | according to Appendix H of the [OMA-CPM- |
| | | | | TS-Conv-Func] and [RFC3841]. |
| | | To-Path | MSRP | Set by the CBP |
| | | From-Path | MSRP | Set by the CBP |
| | | Message-ID | MSRP | Set by the CBP |
| | | Byte-Range | MSRP | Set by the CBP per the byte chunk being |
| | | | | sent. |

As shown in TABLE 1, the mapping of message attributes to message parameters may include converting a hyper-text transfer protocol (HTTP) header or a JavaScript Object Notation (JSON) value of the iMessage into at least one of a common presence and instant messaging (CPIM) header, a CPIM body, a session initiation protocol (SIP) header, a SIP uniform resource identifier (URI), or a message session relay protocol (MSRP) value of an RCS message. For example, as shown in TABLE 1, the “sourceid” attribute of an iMessage may include a JSON value which is converted into the “P-Asserted-Identity” parameter formatted in a SIP header of the RCS message 434.

In some examples, a single iMessage attribute is mapped to a plurality of RCS parameters. In another example, several iMessage attributes are mapped to a single RCS parameter. In yet another example, one or more iMessage attributes may be ignored (i.e., not mapped) as information contained in the iMessage attribute is unnecessary to generate a corresponding RCS message 434.

Still referring to FIG. 4, the RCS to business chat converter 420 may include one or more instructions, which when executed by the one or more processors 412 direct the RCS server 402 to perform operations related to converting an RCS message 438 into a business chat message 436 that is formatted according to the third-party proprietary protocol.

In some aspects, the RCS message 438 received by the RCS to business chat converter 420 is a session initiation protocol (SIP) message or a message relay protocol (MSRP) message.

In one aspect, the RCS to Business chat converter 420 is configured to format the generated business chat message 436 according to the third-party protocol to include a plurality of message attributes (e.g., content-type, content-encoding, source-id, destination-id, etc.). Thus, the RCS to business chat converter 420 may be configured to map the message parameters of the RCS message 438 to message attributes of the business chat message 436. Table 2, below, illustrates an example mapping of RCS message parameters to business chat message attributes (e.g., attributes of an iMessage) that may be utilized by the RCS to business chat converter 420.

TABLE 2

| RCS | | iMessage | | |
|---|---|---|---|---|
| Parameter | Type | Parameter/Sample | Type | |
| N/A | | content-type | HTTP Header | Set to |
| | | | | “application/JSON” |
| N/A | | content-encoding | HTTP Header | gzip |
| N/A | | authorization | HTTP Header | |
| N/A | | send-token | HTTP Header | CBP sends back the |
| | | | | same token that |
| | | | | was sent in the |
| | | | | initial request from |
| | | | | Apple |
| imdn.Message-ID | CPIM Header | id | HTTP Header | Set to the |
| | | | | imdn.Message-ID |
| From | SIP Header | N/A | | Not Mapped |
| P-Asserted-Identity | SIP Header | source-id | HTTP Header | Translated by the |
| P-Asserted-From | SIP Header | | | CBP to the |
| | | | | corresponding |
| | | | | routable |
| | | | | originating user's |
| | | | | address when P- |
| | | | | Asserted-From is |
| | | | | not available. |
| | | | | When PAF is |
| | | | | available, |
| | | | | translated by the |
| | | | | CBP to the |
| | | | | corresponding |
| | | | | routable |
| | | | | originating user's |
| | | | | address |
| From | CPIM Header | N/A | | Not Mapped |
| To | SIP Header | N/A | | Not Mapped |
| P-Associated-To | SIP Header | destination id | HTTP Header | Translated by the |
| To | CPIM Header | | | CBP to the |
| | | | | corresponding |
| | | | | routable target |
| | | | | user's AppleID |
| | | | | address for the |
| | | | | INVITE. When PAT |
| | | | | is not Present use |
| | | | | CPIM To |
| imdn.Message-ID | CPIM Header | “id” | JSON Value | Set to the |
| | | | | imdn.Message-ID |
| From | SIP Header | N/A | | Not Mapped |
| N/A | | “destinationId” | JSON Value | Same value as |
| | | | | “destination-id” |
| | | | | HTTP Header |
| RURI | SIP URI | N/A | | Not Mapped |
| To | CPIM Header | N/A | | Not Mapped |
| content-type | CPIM Header | “type” | JSON Value | “text/plain; |
| | | | | charset = UTF-8” is |
| | | | | mapped to “text” |
| <CPIM body of message> | CPIM Body | “body” | JSON Value | Set to the JSON |
| | | | | value from CPIM |
| | | | | body |
| | | “v” | JSON Value | Set to default |
| | | | | value of 1 |
| Subject | CPIM Header | “intent” | JSON Value | (Optional) The |
| | | | | intent of the chat |
| | | | | specified by the |
| | | | | business. |
| NS: TMO <mailto:rcs@t- | CPIM Custom Header | “group” | JSON Value | (Optional) The |
| mobile.com> | | | | group identifier for |
| TMO.department | | | | the chat specified |
| | | | | by the business, |
| | | | | for example, a |
| | | | | department name. |
| | | | | This value is either |
| | | | | passed to CBP or |
| | | | | retrieved by CBP |
| | | | | from the CDB for |
| | | | | the department |
| | | | | name |
| | | “locale” | JSON Value | (Optional) The |
| | | | | customer's locale. |
| | | | | Set to default |
| | | | | value of “en-US” |

| | | | |
|---|---|---|---|
| NS: TMO <mailto:rcs@t- | CPIM Custom Header | N/A | Not Mapped |
| mobile.com> | | | |
| TMO.source | | | |
| imdn.Disposition- | CPIM Header | N/A | Not Mapped |
| Notification | | | |
| Content-Length | CPIM Header | N/A | Not Mapped |
| Conversation-ID | SIP Header | N/A | Not Mapped |
| Contribution-ID | SIP Header | N/A | Not Mapped |

| | | | |
|---|---|---|---|
| N/A | “destinationId” | JSON Value | Same value as |
| | | | “destination-id” |
| | | | HTTP Header |
| N/A | “sourceId” | JSON Value | Same value as |
| | | | “source-id” HTTP |
| | | | Header |

| | | | |
|---|---|---|---|
| Expires | SIP Header | N/A | Not Mapped |
| Content-Type | SIP Header | N/A | Not Mapped |
| Content-Length | SIP Header | N/A | Not Mapped |
| Call-ID | SIP Header | N/A | Not Mapped |
| User-Agent | SIP Header | N/A | Not Mapped |
| Cseq | SIP Header | N/A | Not Mapped |
| Max-Forwards | SIP Header | N/A | Not Mapped |
| Via | SIP Header | N/A | Not Mapped |
| Contact | SIP Header | N/A | Not Mapped |
| Accept-Contact | SIP Header | N/A | Not Mapped |
| To-Path | MSRP | N/A | Not Mapped |
| From-Path | MSRP | N/A | Not Mapped |
| Message-ID | MSRP | N/A | Not Mapped |
| Byte-Range | MSRP | N/A | Not Mapped |

As shown in TABLE 2, the mapping of message parameters to message attributes may include converting one or more of a CPIM header, a CPIM body, a SIP header, a SIP URI, or a MSRP value of RCS message 438. For example, as shown in TABLE 2, the “P-Asserted-Identity” parameter formatted in a SIP header of the RCS message 438 is converted into the “sourceid” attribute of an iMessage that includes a JSON value.

In some examples, a single RCS parameter is mapped to a plurality of iMessage attributes. In another example, several RCS parameters are mapped to a single iMessage attribute. In yet another example, one or more RCS parameters may be ignored (i.e., not mapped).

FIG. 4 further illustrates a user ID module 422 that may include one or more instructions, which when executed by the one or more processors 412 direct the RCS server 402 to perform operations related to determining an ID of the intended recipient of the business chat message 432 based on at least one message attribute 440 of the business chat message 422. For example, in one aspect, the business chat message 432 may include a message attribute (e.g., desintationID) that is associated with an intended recipient of the business chat message 432. In response to receiving the message attribute 440, the user ID module 422 may query a profile database 430 with the message attribute 440 to obtain an ID of the intended recipient.

In some examples, the ID of the intended recipient is a Uniform Resource Identifier (URI) associated with a subscriber of the MNO. In another example, the ID is a Mobile Station International Subscriber Directory Number (MSISDN) associated with the subscriber. Once the ID is obtained, the RCS message 434 may then be sent to the intended recipient based on the ID. In some aspects, the RCS message 434 is transmitted to the intended recipient via any of the various interfaces illustrated in the communications network 100 of FIG. 1.

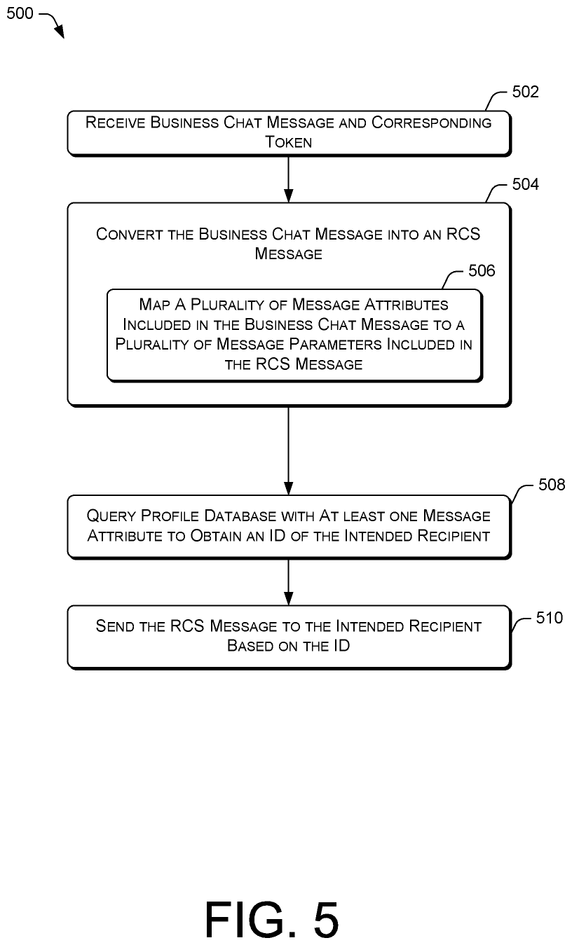

FIG. 5 is a flow diagram of an example process 500 for business chat to RCS interworking. Process 500 is one possible process performed by RCS server 402 of FIG. 4. In a process block 502, the business chat message to RCS converter 418 receives a business chat message 432. In one aspect, the business chat message 432 may be received from a business chat server 180 that is owned and operated by a third-party that is independent of the MNO that owns and operates RCS server 402. In addition, the received business chat message 432 may be formatted according to a third-party proprietary protocol (e.g., iMessage) to include a plurality of message attributes (e.g., see message attributes of iMessage illustrated in TABLE 1). In one example, received business chat message 432 includes a token that represents a conversation between the originator of the business chat message 432 and the intended recipient. For example, the token may be represented by the “send-token” message attribute included in an iMessage, as shown above in TABLE 1. Thus, in process block 504, the business chat message to RCS converter 418 may convert the business chat message 432 into an RCS message 434. As shown in FIG. 5, converting the business chat message 432 may include process block 506, where a plurality of message attributes included in the business chat message are mapped to a plurality of message parameters included in the RCS message 434. In one example, mapping the message attributes to message parameters may include the business chat message to RCS converter 418 converting the message attributes according to TABLE 1, listed above.

In a process block 508, the user ID module 422 receives a message attribute 440 from the business chat server 180 and then queries the profile database 430 with the message attribute 440 to obtain an ID of the intended recipient of the business chat message 432. As discussed above, the message attribute may include the destinationID included in the business chat message 432 and the ID obtained from the profile database 430 may include a URI and/or a MSISDN of a subscriber of the MNO. In another example, the obtained ID may include an email address of the subscriber. In process block 510, the RCS server 402 sends the RCS message 434 to the intended recipient based on the obtained ID. In some situations, the intended recipient is a business and thus sending the RCS message 434 to the intended recipient may include sending/routing the RCS message 434 to a customer service platform of the business.

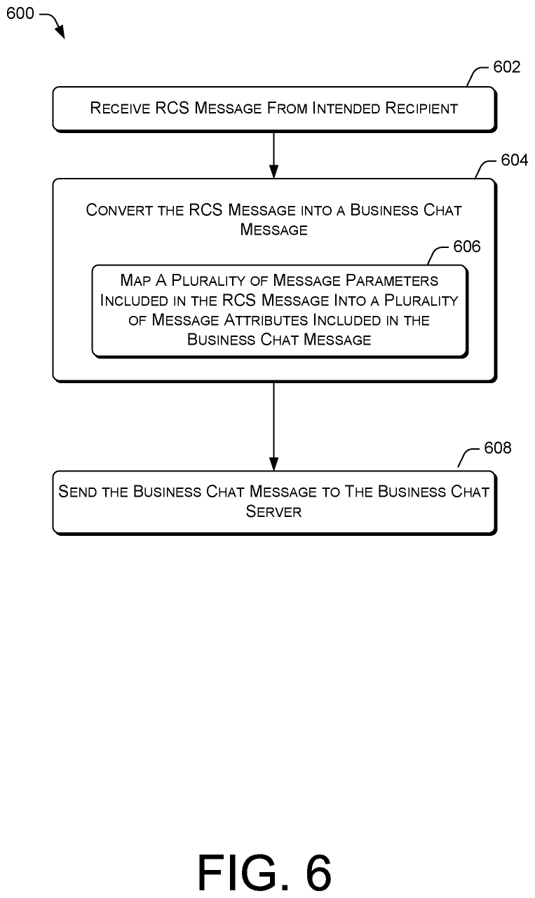

FIG. 6 is a flow diagram of an example process 600 for RCS to business chat interworking. Process 600 is one possible process performed by RCS server 402 of FIG. 4. In a process block 602, the RCS to business chat converter 420 receives an RCS message 438. In one example, the RCS message 438 is received by the RCS server 402 in response to the RCS message 434 sent to the intended recipient (i.e., process block 510 of FIG. 5). Thus, the RCS message 438 may be included in the same message thread (i.e., the same conversation) as RCS message 434. In one aspect, the RCS message 438 is received from the customer service platform of a business associated with the intended recipient of the RCS message 434 and may be received at the RCS server 402 via any of the various interfaces illustrated in the communications network 100 of FIG. 1. Next, in process block 604, the RCS to business chat converter 420 converts the RCS message 438 into a business chat message 436 according to the third-party proprietary protocol (e.g., iMessage). Thus, process a 604, may include process block 606, where the RCS to business chat converter 420 maps a plurality of message parameters included in the RCS message 438 into a plurality of message attributes included in the generated business chat message 436.

In one example, mapping the message parameters to message attributes may include the RCS to business chat converter 420 converting the message parameters according to TABLE 2, listed above. In a process block 608, the RCS server 402 then sends the business chat message 436 to the business chat server 180. As mentioned above, the received business chat message 432 (e.g., process block 502 of FIG. 5) may include a token that represents a conversation between the originator of the business chat message 432 and the intended recipient. For example, the token may be represented by the “send-token” message attribute included in an iMessage, as shown above in TABLE 1. The RCS server 402 may be configured to maintain the received token as part of the message thread corresponding to the received business chat message 432. Thus, the RCS server 402 may be configured to send the token to the business chat server 180 along with the business chat message 436 (e.g., in process block 608) such that the business chat server 180 may forward the business chat message 436 to the originator of the business chat message 432.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method performed by a rich communications services (RCS) server of a mobile network operator (MNO), the method comprising:
receiving a first business chat message from a business chat server, wherein the first business chat message is formatted according to a third-party proprietary protocol to include a plurality of message attributes, and wherein a first message attribute of the plurality of message attributes is associated with an intended recipient of the first business chat message;
converting the first business chat message into a first RCS message, wherein converting the first business chat message into the first RCS message includes:
mapping the plurality of message attributes to a plurality of message parameters included in the first RCS message; and
querying a profile database with the first message attribute to obtain an identification (ID) of the intended recipient; and
sending the first RCS message to the intended recipient based on the ID.

2. The method of claim 1, wherein the first RCS message comprises a session initiation protocol (SIP) message.

3. The method of claim 1, wherein the first RCS message comprises a message session relay protocol (MSRP) message.

4. The method of claim 1, wherein the third-party proprietary protocol is a binary protocol.

5. The method of claim 1, wherein the first business chat message is an iMessage.

6. The method of claim 1, wherein the intended recipient is a business and wherein sending the first RCS message to the intended recipient comprises sending the first RCS message to a customer service platform of the business.

7. The method of claim 1, further comprising:
receiving a second RCS message from the intended recipient;
converting the second RCS message into a second business chat message formatted according to the third-party proprietary protocol; and
sending the second business chat message to the business chat server, wherein the business chat server is configured to forward the second business chat message to an originator of the first business chat message.

8. The method of claim 7, wherein the plurality of message attributes of the first business chat message includes a token that represents a conversation between the originator of the first business chat message and the intended recipient, and wherein sending the second business chat message to the business chat server comprises sending the token to the business chat server.

9. The method of claim 7, wherein the second RCS message comprises at least one of a session initiation protocol (SIP) message or a message session relay protocol (MSRP) message.

10. The method of claim 7, wherein converting the second RCS message into the second business chat message comprises mapping a plurality of message parameters included in the second RCS message to a plurality of message attributes to be included in the second business chat message.

11. The method of claim 1, wherein mapping the plurality of message attributes to the plurality of message parameters comprises converting at least one of a hyper-text transfer protocol (HTTP) header or a JavaScript Object Notation value into at least one of a common presence and instant messaging (CPIM) header, a CPIM body, a session initiation protocol (SIP) header, a SIP uniform resource identifier (URI), or a message session relay protocol (MSRP) value.

12. The method of claim 1, wherein the ID of the intended recipient comprises at least one of a Uniform Resource Identifier (URI) or a Mobile Station International Subscriber Directory Number.

13. A rich communications services (RCS) server of a mobile network operator (MNO), the RCS server comprising:
at least one processor; and
at least one memory coupled to the at least one processor, the at least one memory having instructions stored therein, which when executed by the at least one processor, direct the RCS server to:
receive a business chat message from a business chat server, wherein the business chat message is formatted according to a third-party proprietary protocol to include a plurality of message attributes, and wherein a first message attribute of the plurality of message attributes is associated with an intended recipient of the business chat message;
convert the business chat message into a RCS message, wherein the instructions to convert the business chat message into the RCS message includes instructions to:
map the plurality of message attributes to a plurality of message parameters included in the RCS message; and
query a profile database with the first message attribute to obtain an identification (ID) of the intended recipient; and
send the RCS message to the intended recipient based on the ID.

14. The RCS server of claim 13, wherein the business chat message is an iMessage and wherein the RCS message includes at least one of a session initiation protocol (SIP) message or a message session relay protocol (MSRP) message.

15. The RCS server of claim 13, wherein the instructions to map the plurality of message attributes to the plurality of message parameters comprises instructions to convert at least one of a hyper-text transfer protocol (HTTP) header or a JavaScript Object Notation value into at least one of a common presence and instant messaging (CPIM) header, a CPIM body, a session initiation protocol (SIP) header, a SIP uniform resource identifier (URI), or a message session relay protocol (MSRP) value.

16. The RCS server of claim 13, wherein the ID of the intended recipient comprises at least one of a Uniform Resource Identifier (URI) or a Mobile Station International Subscriber Directory Number.

17. One or more non-transitory computer-readable media storing computer-executable instructions, which when executed by the at least one processor of a rich communications services (RCS) server of a mobile network operator (MNO), direct the RCS server to:
receive a business chat message from a business chat server, wherein the business chat message is formatted according to a third-party proprietary protocol to include a plurality of message attributes, and wherein a first message attribute of the plurality of message attributes is associated with an intended recipient of the business chat message;
convert the business chat message into a RCS message that includes at least one of a session initiation protocol (SIP) message or a message session relay protocol (MSRP) message, wherein the instructions to convert the business chat message into the RCS message includes instructions to:
map the plurality of message attributes to a plurality of message parameters included in the RCS message; and
query a profile database with the first message attribute to obtain an identification (ID) of the intended recipient; and
send the RCS message to the intended recipient based on the ID.

18. The one or more non-transitory computer-readable media of claim 17, wherein the business chat message is an iMessage.

19. The one or more non-transitory computer-readable media of claim 17, wherein the instructions to map the plurality of message attributes to the plurality of message parameters comprises instructions to convert at least one of a hyper-text transfer protocol (HTTP) header or a JavaScript Object Notation value into at least one of a common presence and instant messaging (CPIM) header, a CPIM body, a session initiation protocol (SIP) header, a SIP uniform resource identifier (URI), or a message session relay protocol (MSRP) value.

20. The one or more non-transitory computer-readable media of claim 17, wherein the ID of the intended recipient comprises at least one of a Uniform Resource Identifier (URI) or a Mobile Station International Subscriber Directory Number.
